(19) United States
(12) Patent Application Publication
(10) Pub. No.: US 2010/0089240 A1
(43) Pub. Date: Apr. 15, 2010

(54) RANGE HOOD WITH ELECTROSTATICALLY ASSISTED AIR FLOW AND FILTERING

(76) Inventor: Igor A. Krichtafovitch, Kirkland, WA (US)

Correspondence Address: MORRISON & FOERSTER LLP, 1650 TYSONS BOULEVARD, SUITE 400, MCLEAN, VA, 22102, US

(21) Appl. No.: 12/447,153

(22) PCT Filed: Oct. 26, 2007
(86) PCT No.: PCT/US07/22676

§ 371 Date: Apr. 24, 2009

Related U.S. Application Data
(60) Provisional application No. 60/863,087, filed on Oct. 26, 2006.

(51) Int. Cl. B03C 3/34; B03C 3/36; B03C 3/10; F24C 15/20

(52) U.S. Cl. 96/32; 96/95; 96/96; 96/80; 96/84; 96/88; 96/83

(57) ABSTRACT

An improved ventilating range hood includes a sheet metal collecting hood, vented to the outdoors; a variable speed, electronically controllable fan, mounted in such a way as to draw air from a cooking area and out through said vent of said collecting hood; a plurality of air quality sensors capable of detecting both comfort factors and the presence of hazardous substances in the air; an embedded control algorithm which examines the composite output of said discrete air quality sensors, as well as, the trend information and determines from said information an instantaneous ventilation requirement, and a control signal, derived from said algorithm to regulate the fan speed level such that every combination of discrete air quality sensor conditions will have a unique associated fan speed level based on said ventilation requirement. The air quality sensors may include sensors for temperature, humidity, carbon monoxide, smoke, etc.

### CROSS-REFERENCE TO RELATED APPLICATIONS

This application claims the priority of U.S. Provisional Patent Application Ser. No. 60/863,087, filed Oct. 26, 2006, entitled “Range Hood with Electrostatically Assisted Air Flow and Filtering”, the entire disclosure of which is specifically incorporated herein in its entirety by reference.

### BACKGROUND OF THE INVENTION

1. Field of the Invention

The present invention relates to a range hood for evacuating and cleaning air or emitted gas, which contains oily smoke, water steam, and the like generated by cooking on a range or stovetop.

2. Description of the Related Art

In kitchens, two types of ranges are available: one that burns fuel gas (e.g., natural gas, propane, etc.) and may emits, as a byproduct, carbon dioxide gas; and one that uses electric power (see, e.g., devices included in International Class F24). During operation of both types of ranges and, in particular, the latter, vapors are generated during cooking that may include oily smoke, various odors or smells, water vapor and the like.

To address the various gaseous emissions and heat generated by either stove type, various types of range hoods are known in the art. The basic range hood includes a mechanical exhaust or evacuation fan or blower (see, e.g., patent documents included in International Class F24C 15/20). The fan is typically incorporated into a hood main body and operates to draw air or other emitted gas (which may contain the aforementioned oily smoke or vapor generated by cooking) away from the cooking elements and surfaces. The air or emitted gas is then exhausted or evacuated to the outside of a house through an exhaust or evacuating duct. Here, it is arranged so that the hood, which is largely opened downward over the kitchen range, traps the emitted gas. Generally, it is preferable that the range hood be located at a height of 80 to 90 cm above the sources of gaseous emission, e.g., a frying pan placed on the heating or cooking surface or grates.

As is understood by those skilled in the art, the structure and configuration of the exhaust or evacuating fan is an important element of an exhausting range hood. Desirable features include silent or low noise operation while providing sufficient power to provide adequate ventilation and exhaust of gases, vapors and heat from the cooking area.

That is, a silent evacuating fan having a sufficient evacuating power is required. The applicants of the present invention have proposed a technique concerning an evacuating fan, which is suitable to apply to such range hood such as described in Japanese Patent No. 260928 and the like. Various prior art techniques concerning the relevant hoods may be found in the Japanese Patents No. 2920494, No. 2920494 and No. 3277250.

Prior art devices and methods are described in the following U.S. Patents:

| Pat. | |
|---|---|
| No. | Title |
| 4,133,300 | Ventilating Range Hood |
| 4,135,315 | Miniaturized Model Kitchen Having Coordinated |
| | Interchangeable And Integratable Modules |
| 4,266,528 | Ducted/Ductless Range Hood |
| 4,363,642 | Control Of Range Hood Emissions |
| 4,453,690 | Mounting Assembly For Cooking Appliances |
| 4,465,256 | Mounting Device For Range Hoods |
| 4,610,705 | Filter For Ductless Range Hood |
| 4,614,177 | Multi Feature Range Hood |
| 4,682,580 | Exhaust System For A Cooking Apparatus |
| 4,796,850 | Cooking Apparatus For Mounting On A Wall |
| 4,824,061 | Mounting Assembly For Cooking Appliances |
| 4,856,493 | Quick Connect-Disconnect Panel Mounting Means |
| 4,867,047 | Ventilator Door And Fan Control Assembly For Range Hood |
| | Of A Recreational Vehicle |
| 4,898,149 | Cord-Connected Hood-Backsplash |
| 4,944,782 | Baffle Type Hood And Duct Filters For Commercial Use |
| 5,145,500 | Trimmable Range Hood Filter |
| 5,186,260 | Wire-Sensored Residential Range Hood Fire Extinguisher |
| | System |
| 5,207,276 | Wire-Sensored Fire Extinguisher With Fault-Monitoring |
| | Control System |
| 5,232,152 | Range Hood Fan With Atmospheric Humidity Sensor |
| 5,271,377 | Range Hood Valve Unit |
| 5,328,332 | Wheel Fan Of Range Hood |
| 5,355,026 | Wire-Sensored Residential Range Hood Fire Extinguisher |
| | System |
| 5,690,093 | Ventilator Controller With Variably Adjustable Fan And Light |
| 5,769,155 | Electrohydrodynamic Enhancement Of Heat Transfer |
| 5,824,126 | Soot Filtering Cap In A Range Hood |
| 5,890,484 | Exhaust System For Kitchens |
| 5,981,929 | Heating Cooker With A Space-Efficient Ventilating |
| | Arrangement |
| 6,106,912 | Emblem Mounting Assembly |
| 6,216,686 | Slanted Motor Housing For Range Hood |
| 6,283,117 | Casing Of A Kitchen Range Hood |
| 6,354,287 | Blower Unit For Range Hood And Temporary Fixing |
| | Structure For Blower Unit |
| 6,360,825 | Automatic Fire Extinguisher System For Use On Cookstoves |
| | And Ranges |
| 6,401,709 | Range Hood |
| 6,470,880 | Range Hood |
| 6,622,717 | Over-The-Range Hood |
| 6,662,800 | Range Hood Fan Spray Dispenser |
| 6,712,068 | Cleaning Fluid Heating Reservoir And Motor Assembly For |
| | A Range Hood |
| 6,732,729 | Range Hood With Grease Collecting Motor Housing |
| 6,752,143 | Range Hood Housing |
| 6,752,711 | Motor Housing For Range Hood |
| 6,776,152 | Range Hood |
| 6,802,310 | Kitchen Range Hood With Perimeter Air Inlet |
| 6,802,311 | Kitchen Range Hood Motor Housing And Fan |
| 6,851,422 | Cleaning Fluid Heating Reservoir And Motor Assembly For |
| | A Range Hood |
| 6,874,497 | Range Hood Cleaning Fluid Reservoir And Heating System |
| 6,920,874 | Intelligent Ventilating Safety Range Hood |
| 6,926,000 | Range Hood Motor Housing And Fan Connector |
| 6,945,244 | Range Hood |
| 6,948,454 | Airflow Apparatus |
| 7,111,622 | Range Hood For Venting Gases From Above A Cooking |
| | Surface |
| 7,182,805 | Corona-Discharge Air Mover And Purifier For Packaged |
| | Terminal And Room Air Conditioners |
| 7,197,788 | Range Hood Cleaning Assembly |
| 7,220,295 | Electrode Self-Cleaning Mechanisms With Anti-Arc Guard |
| | For Electro-Kinetic Air Transporter-Conditioner Devices |
| 7,226,496 | Spot Ventilators And Method For Spot Ventilating |
| | Bathrooms, Kitchens And Closets |
| 7,226,497 | Fanless Building Ventilator |
| 7,269,008 | Cooling Apparatus And Method |
| 7,276,106 | Electrode Wire Retaining Member For An Electrostatic |
| | Precipitator |

The following International patents describe further related devices and methods:

| Pub. No. | Ser. No. | Title | Applicant |
|---|---|---|---|
| JP58030353 | JP19810130433 | Range Hood | Matsushita |
| | 19810819 | Type | Electric Ind |
| | | Electrostatic | Co Ltd |
| | | Fume | |
| | | Precipitator | |
| WO/1999/055466 | PCT/US1999/009010 | Method and | MSP |
| | | Apparatus for | Corporation |
| | | Thin | |
| | | Film | |
| | | Deposition | |
| | | on Large Area | |
| | | Substrates | |
| WO/1995/034784 | PCT/US1995/007794 | Apparatus and | Thermal |
| | | Method for | Energy |
| | | Reducing | Systems, |
| | | Particulate | Incorporated |
| | | Emissions from | |
| | | Combustion | |
| | | Processes | |
| RU2156662 | RU19970114740 | Electrostatic | Jurosell |
| | 19960208 | Precipitator and | S A P |
| | | Air Supply | (Ch) |
| | | Terminal | |

While some prior art devices have included some level of filtering of the exhaust, performance of such devices has generally proved inadequate. For example, U.S. Pat. No. 4,921,509 of Maclin entitled “Air filtration system for ducted range hoods” implements an electronic filter section means positioned between an oil mist bag filter system and an outlet of the housing for causing an electrostatic action to remove fine particles from the cooling effluent of the air drawn through the system. The device, however, does not move or accelerate air and uses a conventional fan or blower with all drawbacks that may be found in other inventions mentioned above.

Thus, one problem present in current range hoods is that none can provide silent or near silent operation. Instead, the mechanical exhaust fans and/or blowers generate significant noise and are thereby discomforting and/or an annoyance to nearby room occupants in kitchen and dining room area. In addition, such exhaust fans consume substantial amount of electrical power particularly when HEPA filters and similar devices are incorporated into a range hood requiring additional power to provide a desired airflow. Yet another problem with such devices is that air from a separate or integral oven portion should be either cleaned or discharged outside of the kitchen. Such problems have been exacerbated by improvements in home construction techniques and practices providing enhanced insulation and air-tightness. These building improvements make it more difficult to supply and evacuate air by means of air supply fan or natural convection alone.

Other disadvantages of conventional exhausting range hoods include:
Existing filters are expensive and do not provide sufficient cleaning, especially from ultrafine particles and living microorganisms;
Current range hoods are heavy and consume valuable space in the kitchen even at the time they are not used; and
Current range hoods do a poor job of removing malodors associated with some cooking processes.

### SUMMARY OF THE INVENTION

Embodiments of the present invention address the aforementioned limitations and disadvantages of conventional ventilating and exhausting range and stove hoods. In particular, use of electrostatically assisted air acceleration may be implemented such that embodiments of the present invention that may simultaneously draw air up and clean it to remove most or substantially all impurities.

Accordingly, an object of the present invention is to provide a range hood that is capable of not only silently evacuating air or gasses emitted from an area such as above or in proximity to a food preparation device (e.g., stove, oven, etc.) which produces or emits gases (including hot gases) that may contain, for example, entrained particulates including vapors and the like. Embodiments of the invention not only provide ventilation for the emissions and process the exhaust within the house, but also are capable of providing entertainment to the users by acting a sound transducer, e.g., loudspeaker, for music and other audio programming. It should be noted that, while the present examples of embodiments according to the present invention are directed to range hoods, such embodiments are equally applicable to other applications including, for example, laboratory chemical and fume hoods as used in laboratories, etc.

Embodiments of the invention further address the above detailed and other deficiencies of the prior art. One of these deficiencies involves use of motor driven fan according to the prior art is the failure to provide silent air movement. Another deficiency overcome by embodiments of the present invention is a limited ability of conventional technology to clean and disinfect air. This is a particular issue for a range hood since the cooking process produces oil fumes, water vapor, malodor and so forth from the burned or cooked product, with fine particles left to drift throughout the surrounds, i.e., kitchen, dining room and nearby rooms and areas. Absent an efficient and economical method to remove contaminants, odors, and other materials and substances from the air, the “dirty” air cannot be recycled but is instead discharged to the outside of the house making it necessary to bring in and condition outside air to replace the exhausted air.

Yet another deficiency of the prior art is a failure to incorporate additional entertainment features such as music, sound effects, or soothing sounds and/or reduce sound produces by the cooking process and/or by the exhaust mechanism itself (e.g., range hood).

Thus, the present invention is directed to an apparatus and method for enhancing the efficiency of moving and cleaning air, incorporating an ionic gas propulsion mechanism, such as a corona discharge device, to transport ambient air through an exhaust/range hood. The exhaust/range hood contains an Electrostatic Fluid Accelerator (EFA) that is configured to draw or suck air from, for example, a food preparation area or device such as an oven, and clean the air by removing particulates, vapors, odors, etc. by the electrostatic force.

Embodiments of the invention further include air scrubber functions for collecting particulates and aerosols present in the air including combustion byproducts, water vapor and odors. Further embodiments include audio modulation of the air to produce sound, such as music or simulated natural noise, and/or cancel or attenuate undesirable sounds and noises, such as oven or frying pan sound.

The present invention includes embodiments in the form of a device for efficiently ventilating a room. The device may be placed near (e.g., above) a work area or other area requiring ventilation (such as an oven or at any other place that is close to the oven) and sucks the air from the area/device to be ventilated (e.g., oven) oven. Embodiments of the invention may include an airflow path having an intake or inlet for receiving oven exhaust and an exhaust port or outlet to return clean air to the room.

An Electrostatic Fluid Accelerator (EFA) may be preferably mounted directly above the oven to force air through the airflow path from the inlet to the outlet and back to the room. A Power Supply may be mounted on the range hood itself or at another place and connected to the EFA via high voltage wires or a cable. This cable may be located in a special conduit made of an insulating sleeve material. The sleeve or conduit may run along the side of the range hood from PS to EFA to provide a protective path for the cable.

The EFA is located in the direct air flow that may be hot and moist while a High Voltage Power Supply (HVPS) is preferably located in comparatively cooler area suitable for operation of the electronic circuitry. The EFA may typically include at least two electrodes. One of the electrodes is a corona electrode, preferably in the form of a sharp needle or small diameter wire. The other electrode is a collecting electrode, preferably in the form of a larger diameter wire or other geometry that provides a larger size electrode than that of the corona electrode. Respective groups of each of the electrodes (e.g., an array of corona electrodes and an array of collecting electrodes) are located parallel to each other, space at a distance of from several /millimeters to a couple of inches but preferably between ½ and 3″.

The HVPS generates and supplies a high voltage between the corona and collecting electrodes that typically ranges between 8 and 60 kV. When the voltage applied to the corona electrode relative to the collecting electrode exceeds a so called corona onset voltage a corona discharge takes place in a region surrounding and extending a short distance from the corona electrode. The corona discharge causes an emission of air ions from the corona electrodes that are attracted to the collecting electrode by the electrostatic force existing between the electrodes due to the potential difference. While transiting from one electrode to the other the ions collide with neutrally charged ambient air molecules that are thereby accelerated toward the collecting electrode creating what is sometimes called termed an ionic wind.

Aspects of the invention further address certain unwanted byproducts of both the ionic wind generation process and caused by the combustion of certain fuels such as wood. For example, in addition to accelerating and moving air, corona discharge produces by-products, most noticeably ozone, a potential health hazard in high concentrations and prolonged exposures. The excessive production of ozone may limit ionic wind application to some extent.

One aspect of embodiments of the invention is based on the recognition that ozone is a relatively unstable gas that, under proper conditions, easily converts or dissociates into molecular oxygen. The rate of conversion depends on many factors among which air temperature and air contaminations are predominant. Accordingly, embodiments of the invention effectively incorporate an EFA device in applications involving heated and hot air or other gases and/or fluids wherein the inherent degradation of ozone back to atomic oxygen is supported and/or enhanced by an elevated temperature of the environment and presence of odor and other contaminants to which ozone is reactive to so as to reduce or eliminate any risk of ozone exposure. Embodiments of the current invention implement this natural method to enhance ozone decay to efficiently and silently move hot air into the house. Aspects of the invention accomplish this by propelling and transporting air through the duct of the range hood while maintaining an ozonated portion of the air in warm and contaminated area for some appropriate time period that may be greater than the normal dwell or latency period of the ozonated air absent structure and/or methods to increase ozone degradation.

The time for degradation of ozone back to molecular oxygen necessarily depends on the temperature to which the ozone is heated and concentration of different impurities in the air. That is, the higher the air temperature, the shorter the time period required for complete or substantial ozone to oxygen conversion. Thus, the dirtier the air the faster ozone degrades and converts back to oxygen.

Another important factor for efficient ozone to oxygen conversion is that all, i.e., the entire volume, of ozonated air (i.e., air that passed through the corona discharge area) should pass through warm or contaminated area for considerable time. Therefore, the duct of the range hood and EFA itself should be designed in the way to prevent or minimize air bypass via cooler paths/areas that do not provide sufficient temperature to reconvert the ozone back to oxygen.

The invention further contemplates various placements and numbers of EFA devices within and external to a duct within the hood. For example, the EFA may be located at the range hood while the HVPS is located at some other place. That allows creation of a lightweight range hood, that may be removed, stowed, collapsed or folded when not in use.

Another design consideration incorporated into various embodiments of the invention address shock hazards and providing protection from the high operating voltages used by the EFA and its arrays of corona and collecting electrodes. Thus, it may be important to keep the electrodes that are closer to the room interior at some safe electrical potential, preferably at the ground potential, in order to prevent a potential electrical shock hazard through accidental contact with living creatures such as people and pets. In such a range hood the closest powered element to the inlet is the corona electrode or array of corona electrodes. In such a case, to avoid any shock hazard at the inlet, the corona electrode is preferably maintained at some ground potential while the collecting electrode (or array of collecting electrodes) should be energized to and maintained at some high electric potential. Preferably the collecting electrode(s) is (are) maintained at some negative potential relative to the corona discharge electrode(s) such that, with the corona electrode maintained at ground potential, the collecting electrode is energized with a negative high voltage. The preference of polarities is due to the fact that positive corona discharge emits much less ozone that negative corona discharge.

At the same time the collecting electrode should be located at a safe distance from the inlet or exhaust port thereby preventing it from being touched by someone or something that might be harmed or damaged by the high voltage, e.g., people, pets, etc. and to avoid damage to the EFA itself. Behind the collecting electrode may be installed a protective grid that is located at safe distance (preferably at least ˜5-7 cm) from the collecting electrodes that is maintained at some high potential.

Another feature of embodiments of the invention adopts an increased spacing distance between the corona electrodes (i.e. corona wires) and the opposite (termed collecting) electrodes. This feature addresses the primary source of ozone generation. That is, the main and possibly only source of the ozone generation is within and due to the plasma region immediately surrounding the corona wire or the corona ion emitting sharp edges. The distance from the corona electrodes to the collecting electrodes defines two important factors for the ozone minimization. First, when a relatively distance is implemented, an equivalent corona power may be achieved using an increased corona voltage and a decreased corona current wherein power is the vector product of the two. That is, that same air flow may be induced with a larger voltage and smaller current, i.e. with the same electrical power. However, since the ozone generation rate is directly proportional to the corona current, less ozone is generated when the current is minimized. At the same time, the larger spacing distance provides more time for the generated (or other) ozone to disintegrate/dissociate into molecular oxygen.

Another design feature implemented by embodiments of the invention involve the number (or proximity to each other) of the corona wires. If the corona wires are located close to each other they have a tendency to “shadow” the electric field and thus decrease the electric field strength to the wires that are surrounded with the wires on both sides. Due to this physical phenomenon the, inner corona wires emit less corona current than do the outermost corona wires. To prevent this unevenness or variation of the resulting electrostatic field the corona wires may be positioned/located, not one per the collecting electrode (as in the prior art), but at wider internals of, for example, one corona electrode (wire) per two collecting electrodes. Any other spacing between the corona wires that is wider (greater) than the distance between the collecting electrodes is also beneficial.

Outermost corona wires preferably do not emit any current to adjacent conductive walls of the hood and/or air duct of the hood. Therefore, these walls should be covered with electrically insulating material having a low polarization. This insulating material should be located from the outermost corona wires at a distance approximating one half that of the distance between the corona wires themselves.

Another feature of embodiments of the present invention addresses electrode corrosion and contamination that may occur over time. That is, the electrodes of an EFA are naturally contaminated from time to time depending on the amount, type and density of air contaminants present. Embodiments of the invention may incorporate one or both of two methods of electrode cleaning.

According one method and configuration, both the electrodes and substrates supporting the electrodes are made of washable materials that can withstand cleaning using available appliances such as home and industrial dish washers without sustaining any damage. This substrate may be designed in the way to prevent water accumulation in cavities and holes and/or to provide water drainage and removal so as to allow water to drip freely. A combination of waterproofing and drainage paths allows the substrate to dry completely in a short time.

According to another cleaning configuration and method, the electrodes and/or the substrate are constructed of inexpensive materials and are engineered to be readily and easily fabricated. In addition to the use of inexpensive materials, minimum weight of materials facilitates distribution and replacement of replacement electrode arrays such that dirty and/or contaminated electrodes and/or electrode arrays may be easily and cost effectively replaced with new electrodes.

In order to clean the air, i.e., reduce or eliminate airborne contaminants including, for example, cooking byproducts, dust, pollen, spores, airborne pathogens and germs, etc., in air recirculated and delivered back into the room (house) it is preferable to add one more sets of the electrodes to the EFA structure, so called repelling electrodes. This technique is further detailed and described in Applicants US Patent Application Publication No. 20050150384, now U.S. Pat. No. 7,150,780, entitled “Electrostatic Air Cleaning Device” incorporated herein in its entirety by reference. In such a three-electrode configuration as described therein at least three cables should go to the EFA from the HVPS via a special conduit or high voltage (HV) sleeves preventing HV cables from shorting to each other or to the conductive metal portions of the hood or associated duct.

Another design feature of embodiments of the invention address heavy steam as might be generated by boiling water to which the EFA electrodes would then be subjected. The water droplets may accumulate on the electrodes and cause sparking between the electrodes. Embodiments of the invention incorporate one or both of two methods to reduce and/or eliminate resultant sparking.

According to one embodiment, two consecutive (e.g., tandem or serial) EFAs may be installed one after another. The first one (i.e., the EFA closest to air intake and therefore to any boiling water surface) may use either a lower operating lower voltage between the electrodes or adopt an increased distance between the electrodes. In general, it is preferable to have a lower electric field amplitude in the area between the electrodes of the first EFA nearest the air intake.

Other embodiments may use an additional/auxiliary conventional (motorized or motor driven) fan to boost air flow. This fan may assist EFA in pulling more air though the range hood or overcome an air resistance of a pre-filter that may be installed between the EFA and, for example, the stove. This additional fan may be of smaller power than conventionally required in prior art hoods since it pulls less air (with help of the EFA) or may be used only when substantial or heavy smoke (or other particulates, etc.) is coming from the stove.

Further embodiments and features are directed toward operation in the presence of water steam by tilting the EFA so water droplets that may otherwise accumulate on the collecting electrodes instead slide along their length to a special container where water may be collected and removed. It is preferred that a path length over which the water is prone to accumulate on the collector should be minimized since, as the path length increases, the droplet size increases. This can be accomplished by breaking up a single collector electrode structure into several structures and, in a more preferred embodiment, employing multiple angles of tilt, such that the length that a droplet must travel to be collected and removed is decreased. To aid the water droplets in sliding down the collector electrode, the surface of the collecting electrode may have its absolute value of hydrophobicity as high as possible, with preference for having a high hydrophobic value. In another embodiment using the tilted surface, the collecting electrode may be mechanically or otherwise vibrated, such that the rate of water drops sliding down the electrode surface is increased. In another embodiment, a front portion of the collector electrode is physically detached from the rest of the collector electrode such that it can rotate about its axis. According to a still further embodiment, the front portion of the collecting electrode may be made in the form of a cylinder with a squeegee like mechanism situated on or adjacent a side of the cylinder facing away from the corona electrode. When the collecting electrode begins to collect water droplets on its surface (as may be detected by a suitable sensor and associated electronics), the front portion of the collector electrode may be caused to rotate by an appropriate mechanical or electrical device. The rotating front portion of the collector electrodes causes the droplets formed thereon to be collected at the surface of the squeegee and slide down the collector electrode where they are removed from the surface. In one instance the squeegee may be designed to capture the water droplets into a separate channel or reservoir, where the water can be then removed from the system. This system is shown pictorially in FIG. 3.

According to another embodiment, in order to prevent water droplets accumulation on the collecting electrodes the front portion of the collecting electrodes may be heated, preferably with an electrical current, to a temperature exceeding 100° C. To minimize electrical consumption these front portions of the collecting electrodes (e.g. bars) may be hollow, essentially tube-like and electrically separated from the rest of the collecting electrodes body. The front portions of the collector electrode may be designed to collect the majority of the water vapor passing through the system, such that only a small amount of water vapor is collected on the remainder of the collector electrode. The front portion of the collector electrode can be thermally insulated from the remainder of the collector electrode, such that heat applied to the front portion is not readily conducted to the remainder of the electrode, reducing the heating power required for the device. The heated portion of the collector electrode may be heated from resistive heating of the electrode directly, through a resistive heater within the core of the electrode, or otherwise.

In one embodiment, the heating and filtration function of the range hood application, may be directly linked to the environmental (HVAC or otherwise) of the living space, such that the array could silently heat and purify the air the living space even when the cooking range is not in operation and/or operation of the range hood is not required based on cooking range operation (e.g., while the cooking range is operating but not producing some threshold level of fumes, vapors, heated air, etc. requiring exhausting and/or processing of the air.

To reduce or eliminate the problem of hissing or back-corona coming from water droplets collected on the collector electrode, the field intensity at the closest surface of the water droplet may be kept below a critical electric field value that would allow for hissing and or back corona. In one embodiment, the electric field is kept under this minimum value by increasing the distance between corona and collector electrode such that intended EFA and filtration performance is maintained, while reducing the electric field near the collector electrode. By calculating the maximum water steam volume density that the range hood array will be designed for, and the maximum travel length of water droplets along the collector, the maximum droplet size formed on the collecting electrode can be calculated. From this maximum droplet size, the corona to collector electrode gap distance can be calculated, which will maintain an E field at the surface of the water droplet under a critical threshold value.

Further embodiments provide additional features directed to reducing device and ambient noise and/or providing desirable audio while providing heated air comfort with the silent and efficient delivery of return/heated air into the room. One such feature incorporates voltage modulation across the EFA electrodes in response to an audio signal so as to create acoustic sound. When voltage modulates with frequencies between 20 Hz and 20,000 Hz the air acceleration through EFA also accelerates with corresponding frequencies and creates corresponding sound effects. This way music, soothing sounds, or other sonic or even subsonic and supersonic audio may be generated to thereby add one more benefit to the hot air delivery and air cleaning.

Another feature of embodiments of the present invention addresses electrode corrosion and contamination that may occur over time. That is, the electrodes of an EFA are naturally contaminated from time to time depending on the amount, type and density of air contaminants present. Embodiments of the invention may incorporate one or both of two methods of electrode cleaning.

According one method and configuration, both the electrodes and substrates supporting the electrodes are made of washable materials that can withstand cleaning using available appliances such as home and industrial dish washers without sustaining any damage. This substrate may be designed in the way to prevent water accumulation in cavities and holes and/or to provide water drainage and removal so as to allow water to drip freely. A combination of waterproofing and drainage paths allows the substrate to dry completely in a short time.

According to another cleaning configuration and method, the electrodes and/or the substrate are constructed of inexpensive materials and are engineered to be readily and easily fabricated. In addition to use of inexpensive materials, minimum weight of materials facilitates distribution and replacement such that dirty and/or contaminated electrodes and/or electrode arrays may be easily and cost effectively replaced with new electrodes.

In order to gain easy access to the electrodes, the electrodes (e.g., corona and/or collecting electrodes mounted in a frame or cartridge) are mounted on a pivoting frame that opens by swinging down to some open angle. This angle is large enough to allow the cartridge to be readily removed and, at the same time, does not exceed some maximum rotation angle such that the cartridge is urged under it own weight to fall down under the gravity force. The corona frame may be mounted together with the collecting and repelling electrodes as a one whole. According to another embodiment, an array of corona electrodes may be implemented as a separate frame and separately removed and replaced from the range hood as needed.

It should be noted that the geometry, materials, circuit diagrams used for embodiments of the present invention are presented in further detail and disclosed in Applicant's prior applications and patents of Igor Krichtafovitch et al. including U.S. patent application Ser. No. 09/419,720 filed Oct. 14, 1999, now U.S. Pat. No. 6,504,308, entitled Electrostatic Fluid Accelerator; Ser. No. 10/175,947 filed Jun. 21, 2002, now U.S. Pat. No. 6,664,741, entitled Method Of And Apparatus For Electrostatic Fluid Acceleration Control Of A Fluid Flow; Ser. No. 10/188,069 filed Jul. 3, 2002, now U.S. Pat. No. 6,727,657, entitled Electrostatic Fluid Accelerator For And A Method Of Controlling Fluid Flow; Ser. No. 10/295,869 filed Nov. 18, 2002, now U.S. Pat. No. 6,888,314, entitled Electrostatic Fluid Accelerator; Ser. No. 10/352,193 filed Jan. 28, 2003, now U.S. Pat. No. 6,919,698, entitled Electrostatic Fluid Accelerator For And Method Of Controlling A Fluid Flow; Ser. No. 10/187,983 filed Jul. 3, 2002, now U.S. Pat. No. 6,937,455, entitled Spark Management Method And Device; Ser. No. 10/735,302 filed Dec. 15, 2003, now U.S. Pat. No. 6,963,479, entitled Method Of And Apparatus For Electrostatic Fluid Acceleration Control Of A Fluid Flow; Ser. No. 10/847,438 filed May 18, 2004, now U.S. Pat. No. 7,053,565, entitled Electrostatic Fluid Accelerator For And A Method Of Controlling Fluid Flow; Ser. No. 11/210,773 filed Aug. 25, 2005, now U.S. Pat. No. 7,122,070, entitled Method Of And Apparatus For Electrostatic Fluid Acceleration Control Of A Fluid Flow; Ser. No. 10/806,473 filed Mar. 23, 2004, U.S. Patent Publication No. 20040217720, entitled Electrostatic Fluid Accelerator For And A Method Of Controlling Fluid Flow; Ser. No. 10/724,707 filed Dec. 2, 2003, U.S. Patent Publication No. 20050116166, entitled Corona Discharge Electrode And Method Of Operating The Same; Ser. No. 10/752,530 filed Jan. 8, 2004, U.S. Patent Publication No. 20050150384, entitled Electrostatic Air Cleaning Device; Ser. No. 11/046,711 filed Feb. 1, 2005, U.S. Patent Publication No. 20050151490, entitled Electrostatic Fluid Accelerator For And Method Of Controlling A Fluid Flow; Ser. No. 11/119,748 filed May 3, 2005, U.S. Patent Publication No. 20050200289, entitled Electrostatic Fluid Accelerator; Ser. No. 11/214,066 filed Aug. 30, 2005, U.S. Patent Publication No. 20060055343, entitled Spark Management Method And Device; and Ser. No. 11/347,565 filed Feb. 6, 2006, U.S. Patent Publication No. 20060226787, entitled Electrostatic Fluid Accelerator For And Method Of Controlling A Fluid Flow, all of which are incorporated herein in their entireties by reference.

The additional features may be also included according to various embodiments of the invention including use of a thermosensor or thermostat to control the EFA so that it operates to blow air when cooking is in progress. The thermosensor may be configured with appropriate logic to regulate a “speed” (i.e., airflow) of the EFA or any additional fan or both in response to different stages and intensity of the cooking process.

According to another embodiment, a sensor may be used to detect one or more air parameters (e.g., air quality, temperature, humidity, particulate content, ozone, etc.) to determine if it is best to recirculate the air, exhaust all or part to the outside, etc. For example, if the ozone level is increasing within the room, the EFA may sense and detect the increase, increase or decrease air flow accordingly so as to allow the “bad” air to get sucked out until the ozone level drops to some acceptable level, then start/recommence recirculating the air. Other criteria that may be used include factors such as odors, dust, etc., that might dictate whether you recirculate or ventilate.

Since the corona wire may be frequently contaminated by the grease or other sticky and/or harmful contaminations, embodiments may apply a suitable electric current to the wire in order to heat it for some predetermined short time and burn off the contaminants.

Still another embodiment addresses wire sag caused by thermal expansion as the corona electrode heats and thereby expands. The wire heating such as for burning off contaminates should be preferably implemented during the time frame when cooking is not in progress and, therefore, no air movement is needed. At this time, without need for operation of the electrostatic cleaning function, high voltage is not applied to the EFA. Absent application of the high voltage, dislocation of the corona wires due to thermal expansion during a cleaning/heating cycle does not result in arcing, shorting or other forms of high voltage breakdown problems. Alternatively or in addition, the corona wires may be spring loaded or otherwise tensioned to compensate for any sagging occurring due to thermal expansion when the wire is heated. In this case the wire may be heated during operation, for the use of reducing ozone, and/or increasing air-velocity.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 is a perspective view of a range hood including an Electrostatic Fluid Accelerator according to an embodiment of the invention;

FIG. 2 is a perspective view of a range hood including an Electrostatic Fluid Accelerator according to another embodiment of the invention;

FIG. 3 is a cross section of a range hood;

FIG. 4 is a cross section of the EFA according to the current invention;

FIG. 5 is the another cross section of the range hood according to an embodiment of the invention; and

FIG. 6 is a schematic diagram of an embodiment of the invention.

### DETAILED DESCRIPTION

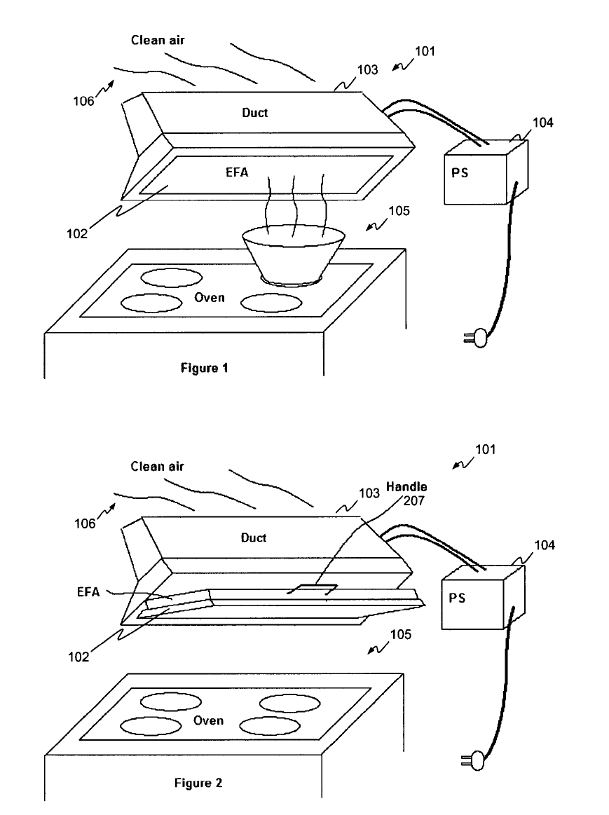

FIG. 1 is a perspective view of a range hood including an Electrostatic Fluid Accelerator (EFA) according to an embodiment of the invention. An electrostatic range hood 101 may include EFA 102 mounted below a hood portion comprising a duct 103. Duct 103 may be formed by the hood structure itself of include a internal cavity constituting the duct. The flared lower portion of range hood 101 includes mounting hardware for removeably retaining EFA 102 in position above range 105. High voltage power supply (HVPS) 104 is shown mounted externally to duct 103 to avoid subjecting the electronics to heat damage and contamination from cooking residue. HVPS 104 may include control circuitry connected to sensors (not shown) that may include sensors for temperature, humidity, carbon monoxide, smoke, noise, etc. A control panel may be included to provide for user operation of the hood and selection of available operating modes and options. Depending on the mode of operation selected, HVPS 104 may be responsive to conditions detected by the various sensors to provide an appropriate voltage output to EFA 102 to generate a desired air flow, air velocity, air modulation (e.g., sound, vibration dampening, etc.) Range 105 may include a plurality of burners (either gas or electric) mounted in an upper stove top surface and a lower oven portion.

FIG. 2 is a perspective view of a range hood including an electrostatic range hood 101 according to another embodiment of the invention. For purposes of maintenance, such as when the electrodes require servicing, cleaning to remove contamination, etc., the hood flips open and electrodes are removed for the cleaning using handle 105. The cleaning may be performed manually or in dishwasher.

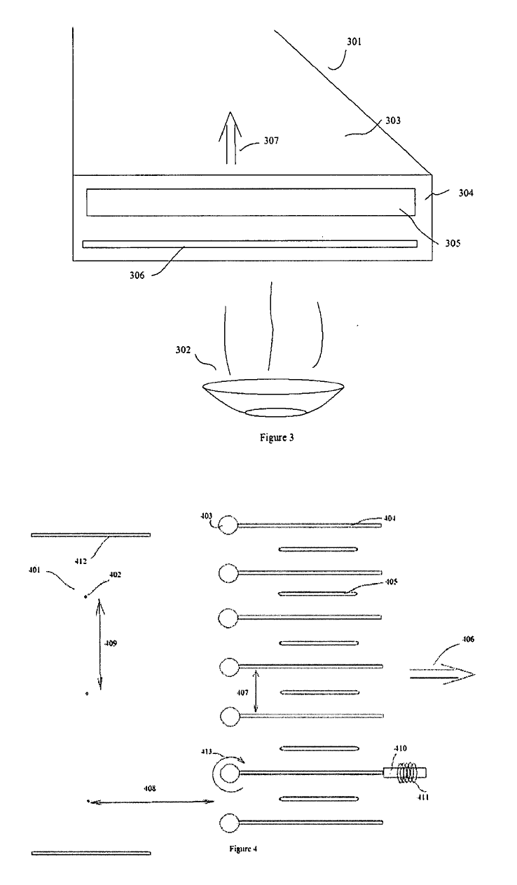

FIG. 3 is a cross section of range hood according to an embodiment of the invention. Range hood 301 is located over the range 302 and includes box 304 and duct 303. EFA is 102 is located and mounted within box 304. Thus, box 304 contains corona electrode 306 and the collecting electrode 305. When HVPS (not shown) applies a high voltage potential between corona electrode 306 and the collecting electrode 305, the ionic wind in the direction 307 sucks air from the range 302 and transport it through duct 303.

FIG. 4 is a cross section of the EFA according to an embodiment of the current invention. EFA 401 includes the corona wire-like electrodes 402 (3 are shown for ease of illustration only), collecting electrodes with front leading edge portions and tail portions 403, 404 (7 collecting electrodes are shown for ease of illustration and in view of the number of corona electrodes depicted) and repelling electrodes 405 (6 are shown, again for purposes of illustration in view in the present example). When the HVPS (not shown) applies a high voltage potential between corona electrodes 402 and the collecting electrodes 403, 404, an ionic wind in a desired exhaust airflow direction 406 is generated. Corona wire 402 preferably has a diameter that is, at most, one-tenth (i.e., at least 10 times smaller) than that of a diameter or thickness of a leading or front portion of collecting electrodes 403.

Repelling electrodes 405 are located between collecting electrodes 404 and serve to enhance air filtration (e.g., collection of particulates entrained in the air) when a suitable electrical potential is applied between these two groups of the electrodes. It is additionally preferable that a spacing distance 408 between the corona electrodes 402 and the collecting electrodes leading edge portions 403 be more than twice the spacing distance between immediately adjacent collecting electrodes 404. It also preferable that a spacing distance 409 between the corona electrodes 402 be greater than spacing distance 407 between immediately adjacent collecting electrodes 404. According to another embodiment of the invention, spacing distance 409 is about twice as large as spacing distance 407 between collecting electrodes 404.

Collecting electrodes 404 may be mechanically connected to a vibrating mechanism for imparting a vibratory motion to the electrodes and inducing vibrations to the collecting electrodes body. That is done to facilitate water droplets sliding along the electrodes and water droplets accumulation. This mechanism is shown in simplified form comprising solenoid 411 and magnetic core 410. Solenoid 411 may be connected to a suitable power supply, such as an AC source, e.g., 60 Hz main or other AC generator. As an option this mechanism may be configured to rotate the front portion 403 in circular direction 413 with the same goal to prevent water and other contaminants from accumulating.

The duct wall (not shown) is spaced apart and separated from corona wires 402 including intervening pieces of insulating materials 412 on the top and the bottom portion of the duct adjacent outermost ones of the corona electrodes. These pieces of the insulating material 412 are preferably located from the outermost corona wires 402 at the distance approximately equal to the half of the distance 409 between the wires themselves. Insulating material 412 may have a low polarization property to prevent undesirable and unpredictable electrical field distortion. Front parts 403 of the collecting electrodes may be hollow. Leading portions 403 may also be covered with a conductive or semiconductive hydrophobic media and/or may be heated to a temperature sufficient to prevent water accumulation (e.g., greater than 100° C.). This heating is preferably performed using a suitable electrical current flowing though these leading edge portions 403 or induced on them. The corona 402, collecting 403, 404 and repelling electrodes 405 are each supported on their respective ends by a support of frame keeping them in designated position, i.e. parallel to each other. These supports (not shown) are preferably made in the manner preventing water accumulation on them thus making the overall structure and separate parts dishwasher safe.

FIG. 5 is a cross section of the range hood according to an embodiment of the invention. EFA 501, shown in side view, contains wire-like corona electrode 502 and collecting electrode 503. When a potential difference is applied between the corona 502 and the collecting 503 electrodes, an ionic wind starts to blow in direction 507. If water vapor is contained in the incoming air, then water droplets may be accumulated on the surface of collecting electrodes 503. To prevent heavy accumulation of water, the entirety of the assembly is tilted so that gravity assists in water removal. This helps water droplets to slide from the left to the right along the surface of the collecting electrodes 503 into a waterproof container 505 where water 506 is accumulated and later removed.

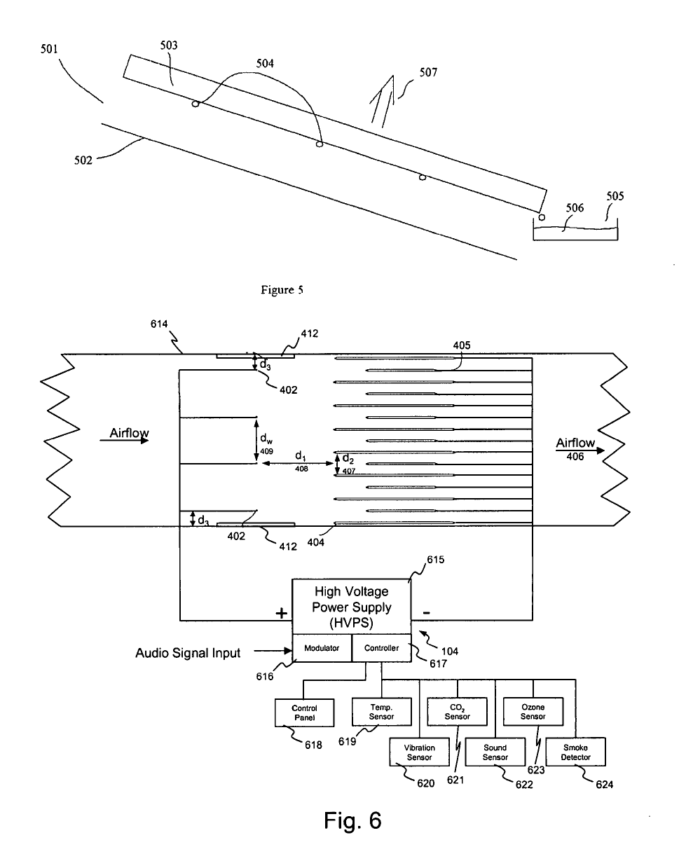

FIG. 6 is a diagram of an embodiment of the invention including an array of electrostatic accelerator electrodes comprising corona electrodes 402, collecting electrodes 404 and (optionally) repelling electrodes 405 located/mounted within a section of duct (shown in cross-section). Electrical insulation 412 may be positioned proximate the outermost corona electrodes 402 so as to cover nearby portions of the duct walls. Insulation 412 may have a low polarization property. Preferably, those electrodes adjacent to any human-accessible openings (e.g., an intake port or exhaust portion of the duct) are maintained at a safe ground potential. For example, if the electrostatic accelerator electrode array of FIG. 6 were located nearest an intake vent so that corona electrodes 402 might be accessible, then it would be preferable to maintain those electrodes at or near ground potential, i.e., connect HVPS 615 with the positive voltage at ground. Conversely, if positioned at an exhaust portion of the duct so that collecting electrodes 404 and/or repelling electrodes 405 might pose a shock hazard (e.g., if the EFA is located remotely from the hood portion such in the exhaust end of an extended air duct used to exhaust air out of a house), those electrodes would be maintained at or near ground potential with corona electrodes 402, mounted further back within the duct, powered with a positive high voltage above ground potential.

A distance d₃ from the outermost corona electrodes 402 to adjacent walls of the duct is approximately one-half (½) a distance d_{w} between adjacent corona wires 402. Electronics 600 includes a high voltage power supply (HVPS) 615 for supplying a suitable high voltage to the electrostatic accelerator electrode array via suitable wiring. A modulator 616 may be included to vary the power supplied to the electrostatic accelerator electrode array to produce a modulated airflow. The modulated airflow may produce a desired sound, be used to cancel undesirable noises, vibrations, etc. Controller 617 may be included to provide for mode and operating feature selection using, for example, control panel 618. Various detectors and sensors including, for example, temperature sensor 619, vibration sensor 620, CO₂ sensor 621, sound sensor 622 (e.g., a microphone), ozone sensor/detector 623, and smoke detector 624 may provide input signals to controller 617 used to control the operation of the EFA in response to those parameters.

In summary, embodiments of the present invention provide an improved ventilating range hood, comprising: a sheet metal collecting hood, vented to the outdoors; a variable speed, electronically controllable fan, mounted in such a way as to draw air from a cooking area and out through said vent of said collecting hood; a plurality of air quality sensors capable of detecting both comfort factors and the presence of hazardous substances in the air; an embedded control algorithm which examines the composite output of said discrete air quality sensors, as well as, the trend information and determines from said information an instantaneous ventilation requirement, and a control signal, derived from said algorithm to regulate the fan speed level such that every combination of discrete air quality sensor conditions will have a unique associated fan speed level based on said ventilation requirement. The air quality sensors may include sensors for temperature, humidity, carbon monoxide, smoke, etc.

While various embodiments and example of the present invention have been provided for purposes of illustration, other variations and alterations may be made. Fore example, the number and arrangement of electrodes may be varied. Further, although embodiments of the invention for use in a home or commercial kitchen, cooking environment have been used for purposes of illustration, other uses (e.g., as an exhaust hood in a laboratory environment, etc.) are contemplated within the scope of the invention.

It should be noted and understood that all publications, patents and patent applications mentioned in this specification are indicative of the level of skill in the art to which the invention pertains. All publications, patents and patent applications are herein incorporated by reference to the same extent as if each individual publication, patent or patent application was specifically and individually indicated to be incorporated by reference in its entirety.

What is claimed is:

1. A range hood for evacuating and cleaning air mounted in such a way as to draw air from a cooking area and clean it with in electrostatic force, said range hood comprising:
a duct for transporting air from an inlet to an outlet of said duct; and
an electrostatic discharge device within said duct for accelerating said gas through said duct from said inlet to said outlet.

2. A range hood of claim 1, said electrostatic discharge device comprising:
a high voltage power supply;
at least one corona electrode connected to said high voltage power supply; and
a collector electrode located proximate said corona electrode and connected to said high voltage power supply so as to induce a motion of the gas in a direction from said corona electrode toward said collector electrode.

3. A range hood of claim 2, said corona electrode is a wire-like conductive member; and
said collector electrode is a conductive member with the smallest dimension at least 10 times greater than the corona wire diameter;
said corona wire and said collecting members are substantially parallel to each other.

4. A range hood of claim 2, further comprising at least one repelling electrode.

5. A range hood of claim 2, where said high voltage power supply is connected to the corona electrode with positive voltage potential with regard to the collecting electrode.

6. A range hood of claim 2, where said high voltage power supply is connected to the repelling electrode with positive voltage potential with regard to the collecting electrode.

7. A range hood of claim 2, wherein said electrostatic discharge device includes a modulator connected to vary an output from said high voltage power supply so as to control said acceleration of said gas in response to an audio signal.

8. A range hood of claim 3, number of the corona wires is equal to the number of the collecting members plus-minus one. (Nw=Nc±1)

9. A range hood of claim 3, number of the corona wires is equal to the number of the collecting members divided by two plus-minus one. (Nw=Nc/2±1)

10. A range hood of claim 3, the distance from the corona wires to the collecting electrodes is more than twice of the distance between the collecting members.

11. A range hood of claim 3, the duct walls in the immediate proximity to the outmost corona wires are covered with insulating material.

12. A range hood of claim 11, said insulating material has low polarization property.

13. A range hood of claim 3, the distance from the outmost corona wires to the duct walls is about ½ of the distance between the wires.

14. A range hood of claim 2, where the electrodes closest to the duct opening accessible to the people are kept under the electrical potential close to the ground potential.

15. A range hood of claim 2, where the electrodes and substrate they are supported with are made with no cavities capable to store water.

16. A range hood of claim 2, where the electrodes and substrate they are kept on are made of cheap material like thin sheet and plastic and easily removable from the duct.

17. A range hood of claim 2, where the collecting electrodes are tilted at the angle sufficient to water droplets to slide along the length of the collecting electrodes' front parts.

18. A range hood of claim 17, were said angle is between 10 and 40 degrees.

19. A range hood of claim 2, where front parts of said collecting electrodes are hollow.

20. A range hood of claim 2, where said collecting electrodes or part of it are made or covered with hydrophobic material.

21. A range hood of claim 2, where said collecting electrodes or part of it are heated to the temperature above 100° C.

22. A range hood of claim 21, where said collecting electrodes or part of it are heated with an electrical current.

23. The range hood of claim 1, wherein said air quality sensors include sensors for sensing one of more of temperature, humidity, ozone, carbon monoxide, and smoke.

24. The range hood of claim 2, where the collecting electrodes or their front part are vibrating or rotating in order to prevent water droplets to get accumulated on the surface.

25. The range hood of claim 1, where the said duct is made flip open to allow the an electrostatic discharge device to be periodically removed for cleaning.
